(19) United States
(12) Patent Application Publication
(10) Pub. No.: US 2016/0141930 A1
(43) Pub. Date: May 19, 2016

(54) Rotor for Electric Power Steering Motor, Electric Power Steering Motor with This, and Manufacturing Therefor

(71) Applicant: Hitachi Automotive Systems, Ltd., Hitachinaka-shi (JP)

(72) Inventors: Hiroshi KANAZAWA, Hitachinaka (JP); Shozo KAWASAKI, Hitachinaka (JP); Kenji NAKAYAMA, Hitachinaka (JP); Yasunaga HAMADA, Hitachinaka (JP); Koichi KASHIWA, Hitachinaka (JP); Masahiro HOSOYA, Hitachinaka (JP)

(21) Appl. No.: 14/884,461

(22) Filed: Oct. 15, 2015

(30) Foreign Application Priority Data
Oct. 16, 2014 (JP) 2014-211309

(51) Int. Cl. H02K 1/28; H02K 1/27; H02K 15/02

(52) U.S. Cl. CPC H02K 1/28; H02K 15/02; H02K 1/27

(57) ABSTRACT

A rotor for an electric power steering motor is configured to include a rotor core having a step skew structure constituted of two independent cores as well as to use shrink fitting to fasten the two cores to a shaft. It may also be configured such that a magnetic center of the rotor core is adjusted by controlling a dimension thereof from a tip of the shaft and by shrink fitting the two cores.

### BACKGROUND OF THE INVENTION

1. Field of the Invention

The present invention relates to a rotor for an electric power steering motor, an electric power steering motor with this, and manufacturing therefor.

2. Description of the Related Art

JP-2004-153913-A and JP-8-322172-A disclose related arts in this technical field. These official journals disclose a rotor for a motor provided with a rotor core having step skew. On an outer periphery of the rotor core, a magnet is bonded, and the rotor core and a shaft are fixed by shrink fitting. Furthermore, JP-2005-304178-A discloses a rotor having no step skew.

### SUMMARY OF THE INVENTION

In the above-described Patent Literatures, it is described that in assembly of the rotor, a means of shrink fitting is used to fasten and fix the rotor core and a shaft; however, actually, there is no description on cogging torque, which is a characteristics of the motor. In a case where it is the simple shrink fitting of the shaft and the rotor core, assembling so as to reduce the cogging torque is difficult. That is because the cogging torque due to the step skew cannot be canceled unless magnitude of the cogging torque generated by a stator core and a magnet on one side is equal to magnitude of the cogging torque generated by the stator core and a magnet on the other side. Furthermore, besides the magnitude of the cogging torque, with regard to a phase, as it is described in JP-61-199447-A that it should be selected where it is minimum around a theoretical skew angle, it is preferred that a skew angle be appropriately determined in an actual magnetic circuit.

The magnitude of the cogging torque is determined by a degree of change in magnetic energy accompanying rotation of the rotor in a state where a magnetic path, in which a magnetic flux going out from each permanent magnet interlinks with the stator core and returns, has been formed. Accordingly, in order to equal the magnitude of the cogging torque, it is necessary to make an overlapping width of each of the permanent magnets and the stator core of the rotor the same. In other words, it is important to match a center of lamination thickness of a stator, or a magnetic center position of a magnetic circuit of the stator, with a border position of the step skew of the rotor (magnetic center of the rotor).

Thus, an objective of the present invention is to provide a rotor for an electric power steering motor capable of being assembled so as to reduce cogging torque, the electric power steering motor with this, and manufacturing therefor.

To solve the above-described problem, a configuration described in claims, for example, is used.

The present invention includes a plurality of means to solve the above-described problem, and examples thereof include a rotor for an electric power steering motor, the rotor including: a rotor core configured to have a step skew structure constituted of two independent cores, wherein shrink fitting is used in fastening the two cores to a shaft.

According to the present invention, it is possible to provide the rotor for the electric power steering motor capable of being assembled so as to reduce the cogging torque, the electric power steering motor with this, and the manufacturing therefor.

Any problem, configuration, and effect other than the above-described ones are clarified in descriptions of an example below.

### BRIEF DESCRIPTION OF THE DRAWINGS

FIG. 1 is a side view of a mechanically and electrically integrated electric power steering motor;

FIG. 2 is a sectional view;

FIG. 3 is a perspective view of a rotor;

FIGS. 4A to 4C are side views of the rotor;

FIG. 5 is a sectional view of a housing;

FIG. 6 is a sectional view of the housing;

FIG. 7 is a perspective view of the rotor; and

FIG. 8 is an explanatory graph illustrating a synthesized waveform of cogging torque.

### DESCRIPTION OF THE PREFERRED EMBODIMENTS

Hereinafter, an example is described by using the drawings.

### Example 1

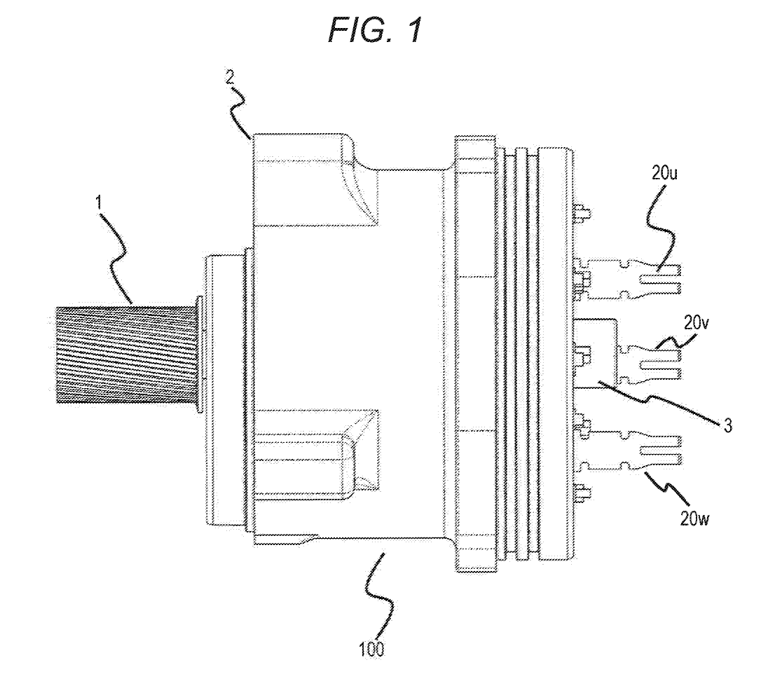

In FIG. 1, there is illustrated only a motor of an electric power steering (hereinafter, abbreviated as EPS) motor unit (EPS motor 100) constituted of the motor and an ECU, which are mechanically and electrically integrated. In the EPS motor 100, a motor constituent component within a housing 2 is housed. As gear driving for an EPS system, a power transfer mechanism is constituted through a pulley 1 and a belt that are provided to the EPS motor 100. Furthermore, it is structured such that the ECU (not illustrated) is connected on a right side of FIG. 1, and three-phase terminals for U, V, and W phases 20u, 20v, and 20w, which are provided to the motor, are electrically connected to the ECU. The EPS motor 100 is also provided with a magnetic pole sensor 3 for detecting a magnetic pole position of a rotor.

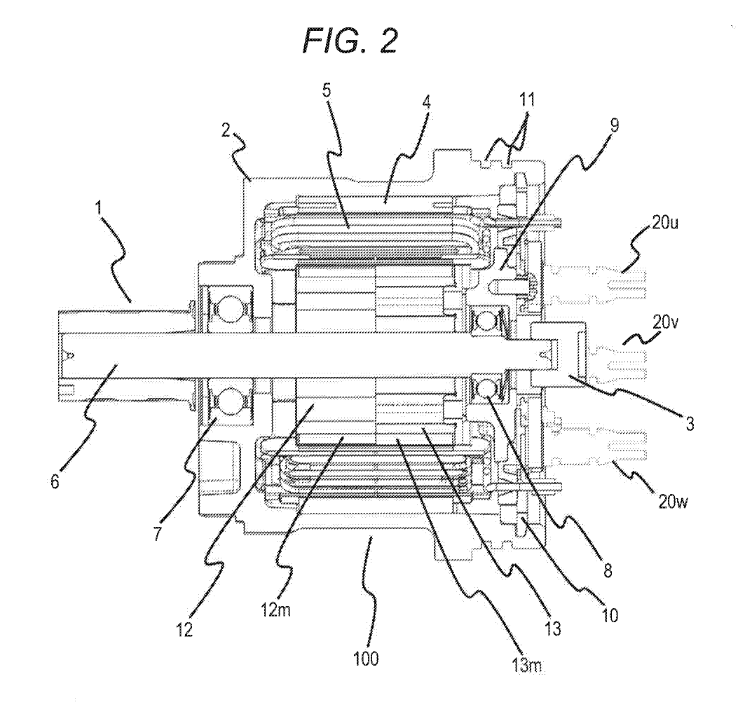

FIG. 2 is a sectional view of the motor illustrated in FIG. 1. A description is given on a configuration thereof. At a center of the motor, a shaft 6 is arranged, and at a tip thereof, the pulley 1 is arranged. At the center of the shaft 6, there are provided an F rotor core 12 arranged on a pulley side and an R rotor core 13 arranged so as to contact the F rotor core 12. Each of the rotor cores is fastened to the shaft 6 by shrink fitting. On an outer periphery of each of the F rotor core 12 and the R rotor core 13, segment-type permanent magnets are arranged. The F rotor core 12 is provided with an F magnet 12m, and the R rotor core 13 is provided with an R magnet 13m. As these permanent magnets, permanent magnets having a residual magnetic flux density of about 1.4 T are used. To the right and left of the above-described rotor cores, an F bearing 7 and an R bearing 8 are provided, respectively. The F bearing 7 is fixed to the housing 2, and the R bearing 8 is fixed to a bearing case 9. On an inner periphery of the housing 2, a stator core 4 is provided. The stator core 4 is provided with a bobbin, and around an outer periphery thereof, a coil 5 is wound. The housing 2 is formed by aluminum die-casting, and airtightness with the above-described ECU is secured by an O-ring groove 11 provided to the housing.

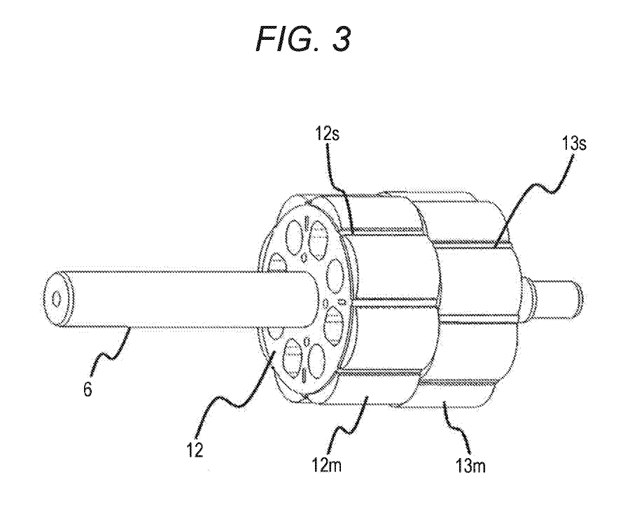

Structure of the rotor is illustrated in FIG. 3. The rotor is constituted of a first rotation unit and a second rotation unit, which has a phase mechanically shifted relative to the first rotation unit. Each of the first rotation unit and the second rotation unit has eight permanent magnets. The first rotation unit is provided with eight F magnets 12m on a surface of the F rotor core 12. The second rotation unit is provided with eight R magnets 13m on a surface of the R rotor core 13. Both of the rotor cores are provided with magnet fixing portions 12s and 13s in the same number as the number of the magnets with an aim to prevent rotation of the magnets and to achieve positioning and fixing of the magnets. The permanent magnets and the rotor cores are fixed together with an adhesive, and a metal protection cover (not illustrated) is provided after the adhesive has dried.

The first rotation unit and the second rotation unit have phases that cancel a waveform of cogging torque. For example, in a case where 8P12S (the number of magnetic poles of a rotor is 8, and the number of slots of a stator is 12) is used, since a main order of the cogging torque is 24^{th} order component, it has a vibration period of 15 degrees in terms of a mechanical angle. Accordingly, at a half thereof, or at around 7.5 degrees, a phase is obtained in which the cogging torque is completely cancelled, whereby the two rotor cores are shrink fitted into the shaft corresponding to this phase.

A description is given on reasons why the shrink fitting is used in the present invention. The first reason is because it is possible to suppress occurrence of contamination since the shaft is not mechanically press-fitted into the rotor core. The second reason is because, for example, when the shaft is press-fitted into the rotor core constituted of a laminated steel sheet, an inner periphery of the rotor core may be deformed due to a load of press-fitting of the shaft, whereby a gap may be generated in an interface of the two rotor cores. There is also a possibility that a metal contamination may be caught in this gap, and the contamination may later come out to inside of the motor. The third reason is because, by shrink fitting the rotor core, punching oil is vaporized and an oil content is removed from a core surface, whereby there is an effect of stabilizing an adhesive condition of the adhesive.

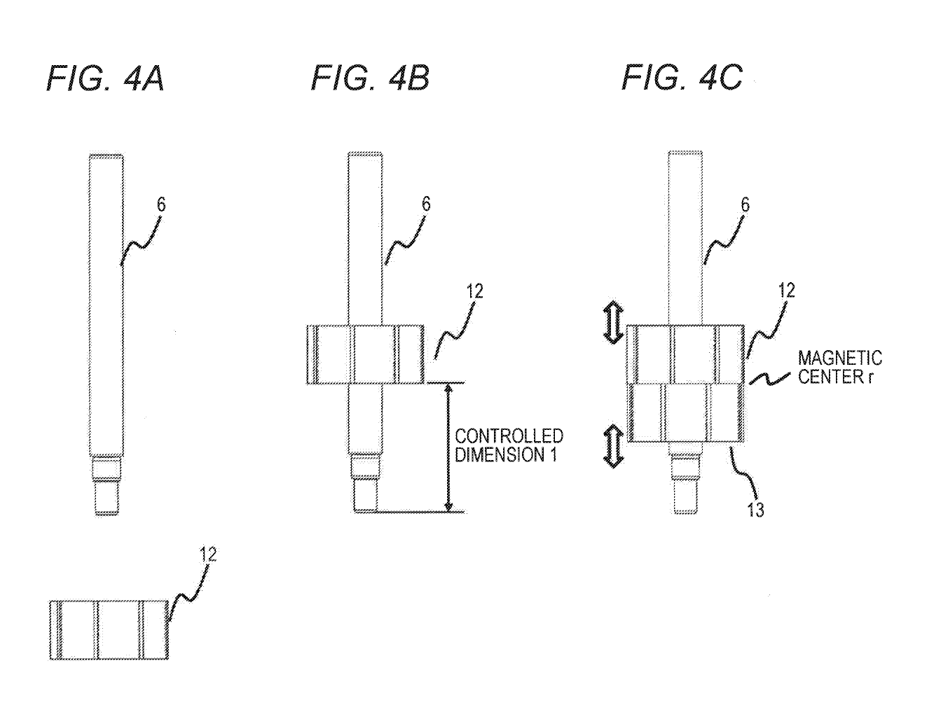

By using FIGS. 4A to 4C, a description is given on assembly of the shaft 6 and the rotor core. To reduce the cogging torque, an important point is how to align a magnetic center of the rotor core having step skew with a magnetic center of the stator core. When these magnetic centers are misaligned, a magnitude of the cogging torque made by the first rotation unit does not match with a magnitude of the cogging torque made by the second rotation unit. Thus, in cancelling the cogging torque by skewing, even when the phases are optimally matched, it is not canceled when a wave height value is different.

The magnitude of the cogging torque accepted by the EPS motor is very small at a several milli-nanometers at 0.2 percentages or below of maximum torque of the motor. When the magnetic centers of the stator core and the rotor core are misaligned, 24^{th} order component of the cogging torque remains, whereby rugged vibration is transmitted to a driver's hand when steering operation is performed. Thus, it is very important that the magnetic center of the stator is aligned with that of the rotor.

One method of assembling in which an axial center of the rotor is aligned with an axial center of the stator is specifically described. A position to make alignment is a border between the two rotor cores of the rotor. A distance between the border and a tip of the shaft, which is a reference for assembling, is controlled to be constant.

One method of controlling the distance is to perform shrink fitting of the rotor core twice as illustrated in FIGS. 4A to 4C. In this case, as illustrated in FIG. 4B, the first shrink fitting is performed at a position of a controlled dimension 1 using an end face of the shaft as the reference. Next, as illustrated in FIG. 4C, the second shrink fitting is performed on the R rotor core 13 by abutting it on an end face of the rotor core on which the first shrink fitting has been performed. At this time, by determining an angle of the R rotor core 13 relative to the F rotor core 12 by using a magnet fixing portion of the F rotor core 12 as the reference or by using a hole provided in the rotor core as the reference, the shrink fitting is performed so as to control a skew angle. Note that by using an outermost periphery of the rotor as the reference, it is possible to improve accuracy and reduce an error in the skew angle.

Besides the method illustrated in FIGS. 4A to 4C, there is also a method of manufacturing by positioning the magnet fixing portion at the magnetic center by a jig and by performing the shrink fitting once. Compared to the method in which the shrink fitting is performed twice as illustrated in FIGS. 4A to 4C, by performing the shrink fitting once, it is possible to improve accuracy in overlapping the holes of the two rotor cores. Note, however, that when the shrink fitting is performed once, it is necessary to increase a temperature during the shrink fitting as well as to increase a gap between the two rotor cores, whereby it is preferred that the method be selected according to a required motor characteristic.

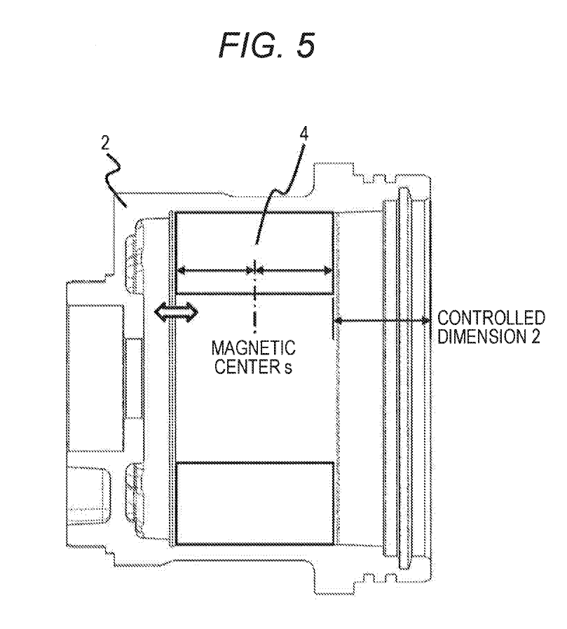

FIG. 5 is a view illustrating a magnetic center s of the stator core 4 to be shrink-fitted into the housing 2. In order to actually align the magnetic center of the stator with the axial center of the rotor, it is preferred that the shrink fitting be performed by measuring lamination thickness of the rotor core each time and by adjusting a controlled dimension 2, although operation may become complicating. Thus, in the shrink fitting of the stator core, it is also possible to control a distance from a reference position on an end face of the housing to an end face of the stator core to be constant as the controlled dimension 2. Fluctuation of the lamination thickness related to a lamination thickness deviation of the stator core occurs in a part denoted by an arrow in the drawing. A lamination thickness deviation of a general core is a thickness of ±one sheet of the core, whereby the lamination thickness deviation of the stator core is ±0.5 when a sheet thickness is 0.5 mm. In the stator, a half thereof becomes an error of the magnetic center at the magnetic center, whereby an error of ±0.25 mm occurs at a maximum.

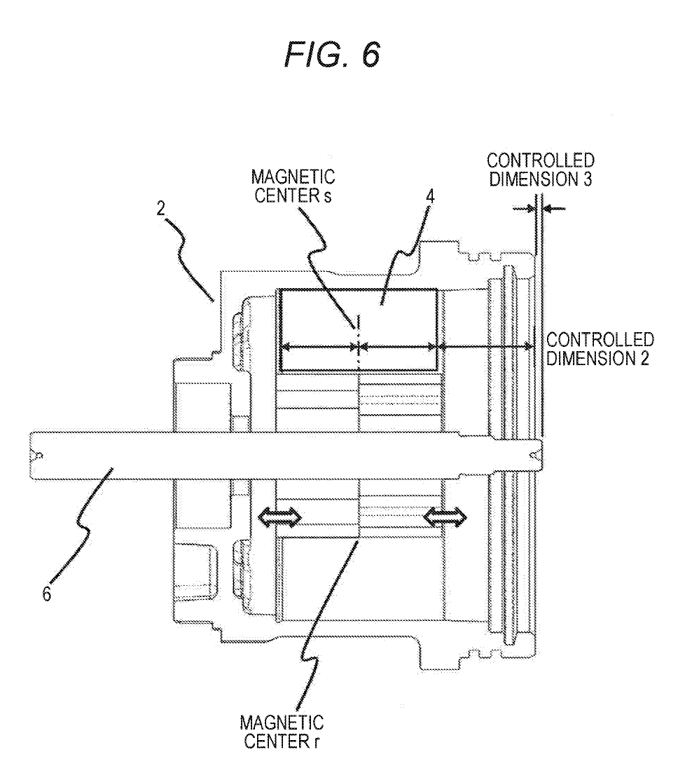

In FIG. 6, an assembly reference for the rotor and the stator is illustrated. As described in FIG. 5, the stator is controlled by the distance from the end face of the housing to the end face of the core. With regard to the rotor, when it is controlled by the end face of the core in the same way as the stator, in the rotor core having two serial steps, in a case where a deviation of ±0.5 mm occurs to each of the cores, a magnetic center with the stator becomes 0.75 mm at a maximum. Thus, variation between the magnitudes of the cogging torque made by the first rotation unit and the cogging torque made by the second rotation unit becomes large. This may result in a problem in that cancellation may not work well. Thus, as described by using FIGS. 4A to 4C, the reference position of the rotor core relative to the tip of the shaft is the border between the cores. Furthermore, by assembling by using a distance between the tip of the shaft and the end face of the housing as a controlled dimension 3, and by separating the lamination thickness deviation of the rotor core from the magnetic center as denoted by arrows in the drawing, the magnitude of the cogging torque made by the first rotation unit and the magnitude of the cogging torque made by the second rotation unit are made uniform, and the cogging torque of a synthesized waveform can be significantly reduced.

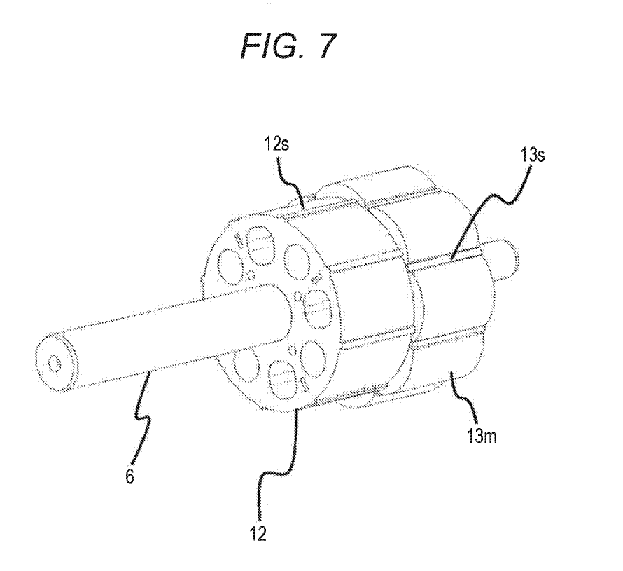

FIG. 7 is an explanatory drawing illustrating positioning of the magnet and the rotor core. The positioning of the magnet in a rotational direction is made by a magnet fixing portion 13s, and in an axial direction, it is made by fixing the magnet by abutting it on an end face of a magnet fixing portion 12s provided to another rotor core. Accordingly, it is possible to manufacture a uniform rotor since a gap between the magnets is eliminated and the end faces of the magnets are aligned precisely with the magnetic center.

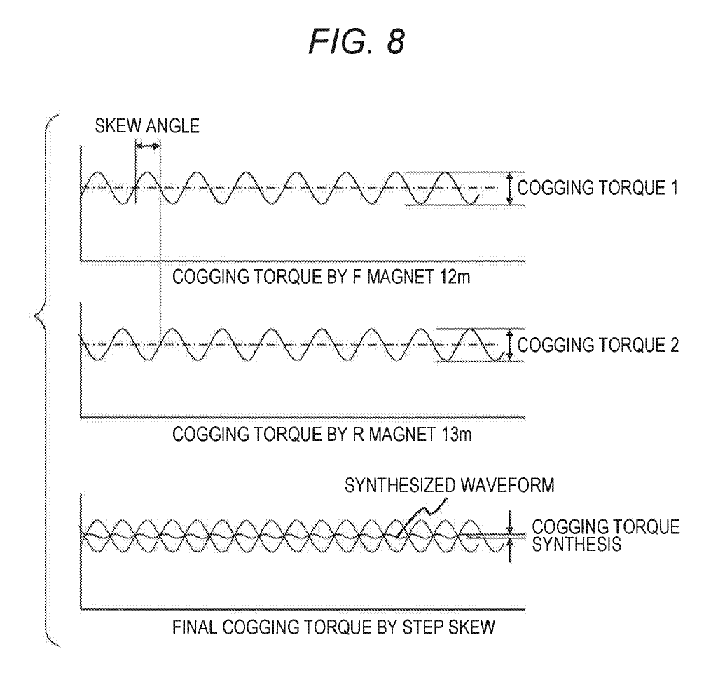

FIG. 8 is a graph illustrating a waveform of the cogging torque made by the first rotation unit and a waveform of the cogging torque made by the second rotation unit as well as a waveform of a synthesized cogging torque.

The cogging torque made by the first rotation unit is expressed in a form in which an AC fluctuating cogging torque is added to a DC friction. A DC component is determined by a hysteresis loss of an iron core and a friction loss of a bearing. In the step skew, an angle is adjusted so as to invert phases of the cogging torque made by the first rotation unit and the cogging torque made by the second rotation unit and so as to cancel a phase of the AC fluctuating cogging torque. As illustrated in the graph, it is possible to make the angle smaller by adjusting the phases and the magnitudes. The angle changes with a saturation condition of a magnetic circuit. Furthermore, as it has been described herein, such that the magnitudes of the cogging torque made by the first rotation unit and the cogging torque made by the second rotation unit are substantially equal and such that the magnetic centers of the rotor core and the stator core are aligned as close as possible, a contacting part between the rotor cores is used as the assembly reference for the rotor.

As described above, in the present invention, the rotor is assembled such that the magnetic centers of the rotor cores align with a position where it is a half of the lamination thickness of the stator and such that each of the magnets is in contact with the magnetic center. Accordingly, it is possible to restrict a position of the magnet in the axial direction, whereby variation of a magnetic flux of each of the magnets in the rotational direction of the magnets can be reduced and fluctuation of the magnetic energy may be suppressed to be small. At this time, the positioning of the magnet in the axial direction can be made by abutting the magnet on an end portion of a rotation stopper of another permanent magnet and, as a result, by causing the permanent magnets to be in contact with each other.

In the present invention, in an electric power steering motor having the step skew, a means of shrink fitting is used to fasten the rotor core to the shaft. Thus, it is possible to suppress deformation of the rotor core caused by mechanical press-fitting and the like between the shaft and the rotor core as well as to accurately assemble the axial center of the rotor. Accordingly, it is also possible to suppress occurrence of the contamination caused by contacting and press-fitting, whereby it is possible to achieve assembly suitable for an electric power steering. As a result, it is possible to achieve reduction of the cogging torque required for the electric power steering motor.

Furthermore, by assembling such that the contacting part of the two rotor cores is the magnetic center, it is not affected by the lamination thickness deviation of the rotor core. Thus, the cogging torque may be decreased compared to when it is assembled by using the end faces of the rotor cores as a reference, whereby as an electric power steering system, it is possible to reduce an influence of the cogging torque transmitted to a driver's hand as well as to provide good steering characteristics.

Note that the present invention is not to be limited to the above-described example and may include various modifications. The above-described example has been described in detail to make the present invention understandable, for example, whereby the example is not to be limited to one provided with all of described constituent elements.

1. A rotor for an electric power steering motor, the rotor comprising:
a rotor core configured to have a step skew structure constituted of two independent cores, wherein
shrink fitting is used in fastening the two cores to a shaft.

2. The rotor for the electric power steering motor according to claim 1, wherein
a magnetic center of the rotor core is adjusted by shrink fitting of the two cores by controlling a dimension thereof from a tip of the shaft.

3. The rotor for the electric power steering motor according to claim 1, wherein
a permanent magnet pasted to one of the cores is provided so as to contact, in an axial direction, a magnet positioning portion provided to the other of the cores.

4. An electric power steering motor provided with the rotor for the electric power steering motor according to claim 1.

5. A method of manufacturing a rotor for an electric power steering motor, the rotor including a rotor core configured to have a step skew structure constituted of two independent cores, the method comprising:
a first shrink fitting of a first core into a shaft in a predetermined position using an end face in an axial direction of the shaft as a reference; and
a second shrink fitting of a second core by abutting the second core on an end face in the axial direction of the first core having been shrink fitted in the first shrink fitting.

6. The method of manufacturing the rotor for the electric power steering motor according to claim 5, wherein
an angle of the second core relative to the first core is adjusted using a magnet fixing portion of the first core or a hole provided in the first core in the second shrink fitting as the reference.

7. A method of manufacturing an electric power steering motor, a rotor core configured to have a step skew structure constituted of two independent cores, the method comprising:
controlling a distance from an end face of a housing to an end face of a stator core in configuring a stator; and
controlling a distance from a tip of a shaft to a border of the two cores in configuring a rotor.

8. The method of manufacturing the electric power steering motor according to claim 7, wherein
a distance from the tip of the shaft to the end face of the housing is controlled.
